(19) United States
(12) Patent Application Publication
(10) Pub. No.: US 2026/0180486 A1
(43) Pub. Date: Jun. 25, 2026

(54) MOTOR CONTROL SYSTEM AND METHOD

(71) Applicant: HL MANDO CORPORATION, Gyeonggi-do (KR)

(72) Inventors: Manoj Kumar Reddy MOTAKATLA, Bay City, MI (US); Raja RAMAKRISHNAN, Bay City, MI (US); Tomy SEBASTIAN, Bay City, MI (US); Scott WENDLING, Bay City, MI (US)

(21) Appl. No.: 18/988,890

(22) Filed: Dec. 20, 2024

(51) Int. Cl. H02P 29/028; H02P 25/22

(52) U.S. Cl. CPC H02P 29/028; H02P 25/22

(57) ABSTRACT

A motor drive system comprises: a motor; first and second power sources; a first electronic control unit connected with the first power source, connected with the motor to control the motor, and comprising a first inverter, a first driver configured to drive the first inverter, and a first microcontroller configured to control the first drive; a second electronic control unit connected with the second power source, connected with the motor to control the motor, and comprising a second inverter, a second driver configured to drive the second inverter, and a second microcontroller configured to control the second driver; and a third electronic control unit connected with the first and second power sources, connected with the motor to control the motor, and comprising third and fourth inverters, third and fourth drivers configured to drive the third and fourth inverters, respectively, and a third microcontroller configured to control the third and fourth drivers.

### BACKGROUND

The present disclosure generally relates to a system and method for controlling a motor. More specifically, some embodiments of the present disclosure relate to a motor control system and method providing a redundancy failsafe for electronic control units (ECUs) operating a motor in a vehicle.

Increasing vehicle safety requirements are driving system redundancy to achieve higher safety levels. Steer-by-wire type vehicles or autonomous vehicles which lack adequate redundancy in drive systems of the vehicle may not be able to continue drive operations when one or more elements or components of the drive system fail or are otherwise inoperative. Ideally, the vehicles ought to incorporate redundancy in the drive systems that will allow the vehicle to continue drive operations, or at a minimum continue drive operations for a limited amount of time until the vehicle may be safely taken out of operation. Therefore, there is a need for redundancy in systems and methods for implementing the steer-by-wire type vehicles or autonomous vehicles.

### SUMMARY

The features and advantages of the present disclosure will be more readily understood and apparent from the following detailed description, which should be read in conjunction with the accompanying drawings, and from the claims which are appended to the end of the detailed description.

According to some embodiments of the present disclosure, a motor drive system may comprise: a motor comprising a plurality of motor windings; first and second power sources; a first electronic control unit electrically connected with the first power source to receive power from the first power source and electrically connected with the motor to control the motor, the first electronic control unit comprising a first inverter, a first driver configured to drive the first inverter, and a first microcontroller configured to control the first drive; a second electronic control unit electrically connected with the second power source to receive the power from the second power source and electrically connected with the motor to control the motor, the second electronic control unit comprising a second inverter, a second driver configured to drive the second inverter, and a second microcontroller configured to control the second driver; and a third electronic control unit electrically connected with the first and second power sources to receive the power from the first and second power sources and electrically connected with the motor to control the motor, the third electronic control unit comprising third and fourth inverters, third and fourth drivers configured to drive the third and fourth inverters, respectively, and a third microcontroller configured to control the third and fourth drivers.

The first electronic control unit may further comprise a first regulator configured to regulate the power supplied from the first power source to the first electronic control unit; the second electronic control unit may further comprise a second regulator configured to regulate power supplied from the second power source to the second electronic control unit; and the third electronic control unit may further comprise a third regulator configured to regulate power supplied from the first and second power sources to the third electronic control unit.

The first electronic control unit may further comprise a first phase disconnector connected between the first inverter and the motor and configured to selectively disconnect electrical connection between the first inverter and the motor; the second electronic control unit may further comprise a second phase disconnector connected between the second inverter and the motor and configured to selectively disconnect electrical connection between the second inverter and the motor; and the third electronic control unit may further comprise a third phase disconnector connected between the third inverter and the motor and configured to selectively disconnect electrical connection between the third inverter and the motor and a fourth phase disconnector connected between the fourth inverter and the motor and configured to selectively disconnect electrical connection between the fourth inverter and the motor.

The plurality of motor windings of the motor may comprise first motor windings and second motor windings; the first electronic control unit may further comprise a first current sensor configured to sense first motor phase currents which are to be provided to the first motor windings of the motor; the second electronic control unit may further comprise a second current sensor configured to sense second motor phase currents which are to be provided to the second motor windings of the motor; and the third electronic control unit may further comprise a third current sensor configured to sense the first motor phase currents which are to be provided to the first motor windings of the motor and a fourth current sensor configured to sense the second motor phase currents which are to be provided to the second motor windings of the motor.

The first, second and third electronic control units may be communicationally connected to each other.

The plurality of motor windings of the motor may comprise first motor windings, connected to the first invertor of the first electronic control unit and the third invertor of the third electronic control unit, and second motor windings, connected to the second invertor of the second electronic control unit and the fourth invertor of the third electronic control unit.

The first electronic control unit may be configured to, when the first power source and the first electronic control unit are in a normal state, provide first motor phase currents to the first motor windings of the motor connected to the first invertor of the first electronic control unit and the third invertor of the third electronic control unit; and the second electronic control unit may be configured to, when the second power source and the second electronic control unit are in the normal state, provide second motor phase currents to the second motor windings of the motor connected to the second invertor of the second electronic control unit and the fourth invertor of the third electronic control unit.

The third electronic control unit may be configured to, when the first electronic control unit is in an abnormal state and the second electronic control unit is in a normal state, provide first motor phase currents to the first motor windings of the motor connected to the first invertor of the first electronic control unit and the third invertor of the third electronic control unit; and the second electronic control unit may be configured to, when the first electronic control unit is in the abnormal state and the second electronic control unit is in the normal state, provide second motor phase currents to the second motor windings of the motor connected to the second invertor of the second electronic control unit and the fourth invertor of the third electronic control unit.

The third electronic control unit may be configured to, when the first electronic control unit is in a normal state and the second electronic control unit is in an abnormal state, provide second motor phase currents to the second motor windings of the motor connected to the second invertor of the second electronic control unit and the fourth invertor of the third electronic control unit; and the first electronic control unit may be configured to, when the first electronic control unit is in the normal state and the second electronic control unit is in the abnormal state, provide first motor phase currents to the first motor windings of the motor connected to the first invertor of the first electronic control unit and the third invertor of the third electronic control unit.

The third electronic control unit may be configured to, when the first electronic control unit and the second electronic control unit are in an abnormal state, provide first and second motor phase currents to the first and second motor windings of the motor.

The first electronic control unit may be configured to, when the third electronic control unit is in an abnormal state and the first and second electronic control units are in a normal state, provide first motor phase currents to the first motor windings of the motor connected to the first invertor of the first electronic control unit and the third invertor of the third electronic control unit; and the second electronic control unit may be configured to, when the third electronic control unit is in the abnormal state and the first and second electronic control units are in a normal state, provide second motor phase currents to the second motor windings of the motor connected to the second invertor of the second electronic control unit and the fourth invertor of the third electronic control unit.

The first electronic control unit may be configured to, when the second power source configured to supply the power to the second electronic control unit and the third electronic control unit is in an abnormal state, provide first motor phase currents to the first motor windings of the motor connected to the first invertor of the first electronic control unit and the third invertor of the third electronic control unit.

The second electronic control unit may be configured to, when the first power source configured to supply the power to the first electronic control unit and the third electronic control unit is in an abnormal state, provide second motor phase currents to the second motor windings of the motor connected to the second invertor of the second electronic control unit and the fourth invertor of the third electronic control unit.

The second and/or third electronic control units may be configured to determine whether the first electronic control unit is in the abnormal state based on one or more of a loss of the power supplied from the first power source or a disconnection of communication from the first electronic control unit.

The first and/or third electronic control units may be configured to determine whether the second electronic control unit is in the abnormal state based on one or more of a loss of the power supplied from the second power source or a disconnection of communication from the second electronic control unit.

The third electronic control unit may be configured to determine whether the first or second electronic control unit is in the abnormal state based on one or more of a loss of the power supplied from the first or second power source or a disconnection of communication from the first or second electronic control unit.

According to certain embodiments of the present disclosure, a method may control a motor drive system comprising a motor comprising first and second motor windings; first and second power sources; a first electronic control unit comprising a first inverter connected to the first motor windings, electrically connected with the first power source to receive power from the first power source, and electrically connected with the first motor windings of the motor to control the motor; a second electronic control unit comprising a second inverter connected to the first motor windings, electrically connected with the second power source to receive the power from the second power source, and electrically connected with the second motor windings of the motor to control the motor; and a third electronic control unit having a third invertor connected to the first motor windings and a fourth invertor connected to the second motor windings, electrically connected with the first and second power sources to receive the power from the first and second power sources, and electrically connected with the motor to control the motor.

The method may comprise: when the first electronic control unit is in an abnormal state, providing, by the third electronic control unit, first motor phase currents to the first motor windings of the motor connected to the first invertor of the first electronic control unit and the third invertor of the third electronic control unit and providing, by the second electronic control unit, second motor phase currents to the second motor windings of the motor connected to the second invertor of the second electronic control unit and the fourth invertor of the third electronic control unit; and when the second electronic control unit is in the abnormal state, providing, by the third electronic control unit, second motor phase currents to the second motor windings of the motor connected to the second invertor of the second electronic control unit and the fourth invertor of the third electronic control unit and providing, by the first electronic control unit, first motor phase currents to the first motor windings of the motor connected to the first invertor of the first electronic control unit and the third invertor of the third electronic control unit.

The method may further comprise, when the first and second power sources and the first and second electronic control unit are in a normal state, providing, by the first electronic control unit, first motor phase currents to the first motor windings of the motor connected to the first invertor of the first electronic control unit and the third invertor of the third electronic control unit and providing, by the second electronic control unit, second motor phase currents to the second motor windings of the motor connected to the second invertor of the second electronic control unit and the fourth invertor of the third electronic control unit.

The method may further comprise, when the first and second electronic control units are in the abnormal state, providing, by the third electronic control unit, the first motor phase currents to the first motor windings of the motor connected to the first invertor of the first electronic control unit and the third invertor of the third electronic control unit and providing, by the third electronic control unit, second motor phase currents to the second motor windings of the motor connected to the second invertor of the second electronic control unit and the fourth invertor of the third electronic control unit.

The method may further comprise: when the second power source configured to supply the power to the second electronic control unit and the third electronic control unit is in the abnormal state, providing, by the first electronic control unit, the first motor phase currents to the first motor windings of the motor connected to the first invertor of the first electronic control unit and the third invertor of the third electronic control unit; and when the first power source configured to supply the power to the first electronic control unit and the third electronic control unit is in the abnormal state, providing, by the second electronic control unit, the second motor phase currents to the second motor windings of the motor connected to the second invertor of the second electronic control unit and the fourth invertor of the third electronic control unit.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 illustrates a schematic diagram of a motor control system according to an embodiment of the present disclosure.

FIG. 2 shows an exemplary case in which a first electronic control unit (ECU) and a second ECU are in a normal state and a first power source and a second power source are in the normal state according to an embodiment of the present disclosure.

FIG. 3 illustrates an exemplary case in which a first power source is in an abnormal state and a second power source is in a normal state according to an embodiment of the present disclosure.

FIG. 4 shows an exemplary case in which a first power source is in a normal state and a second power source is in an abnormal state according to an embodiment of the present disclosure.

FIG. 5 shows an exemplary case in which a first controller of a first ECU is in an abnormal state according to an embodiment of the present disclosure.

FIG. 6 illustrates an exemplary case in which a second controller of a second ECU is in an abnormal state according to an embodiment of the present disclosure.

FIG. 7 shows an exemplary case in which a third controller of a third ECU is in an abnormal state according to an embodiment of the present disclosure.

FIG. 8 illustrates an exemplary case in which one or more of a first driver, a first inverter, a first phase disconnector, a first power supply regulator, a first current sensor, and a first communicator of a first ECU are in an abnormal state according to an embodiment of the present disclosure.

FIG. 9 shows an exemplary case in which one or more of a second driver, a second inverter, a second phase disconnector, a second power supply regulator, a second current sensor, and a second communicator of a second ECU are in an abnormal state according to an embodiment of the present disclosure.

FIG. 10 illustrates a schematic diagram of a motor control system according to another embodiment of the present disclosure.

FIG. 11 illustrates an exemplary case in which a first power source is in an abnormal state and a second power source is in a normal state according to another embodiment of the present disclosure.

FIG. 12 illustrates another exemplary case in which a first power source is in a normal state and a second power source is in an abnormal state according to another embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

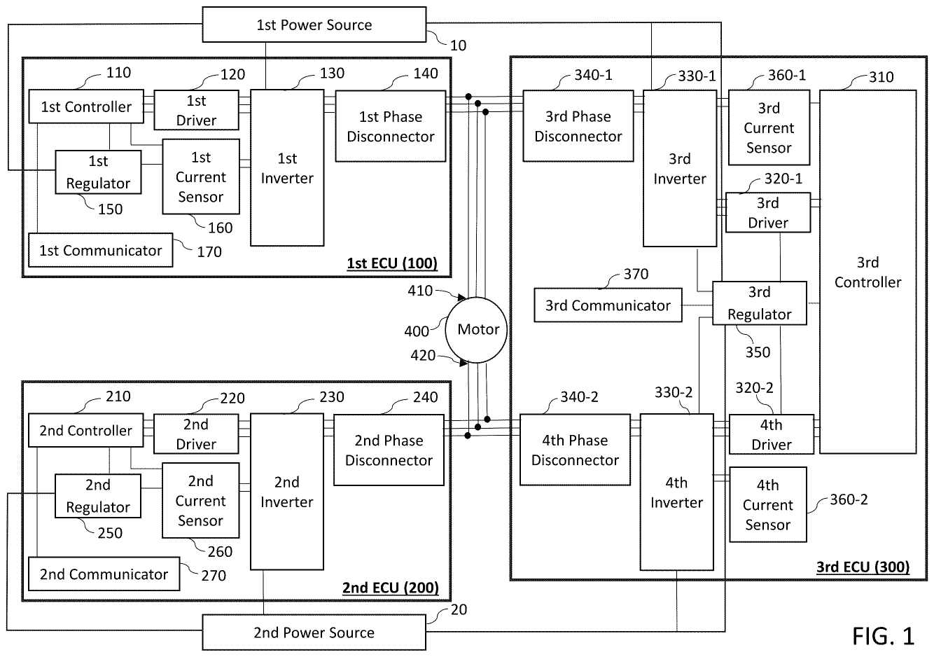

FIG. 1 illustrates a schematic diagram of a motor control system according to an embodiment of the present disclosure.

Power sources 10 and 20 are configured to supply electrical power. For example, each of the power sources 10 and 20 may supply direct current (DC) power to one or more of first, second, and third electronic control units (ECUs) 100, 200, and 300. Power sources 10 and 20 comprises, for example, but not limited to, a battery or a power circuit. In other examples, the power source 10, 20 may be a fuel cell or an electric double-layer capacitor (EDLC) or other source of DC power.

In the exemplary embodiment of FIG. 1, the first power source 10 is electrically connected to the first ECU 100 and the third ECU 300 to supply the power to the first ECU 100 and the third ECU 300, and the second power source 20 is electrically connected to the second ECU 200 and the third ECU 300 to supply the power to the second ECU 200 and the third ECU 300. Accordingly, the third ECU 300 may be electrically connected with both the first power source 10 and the second power source 20.

A motor 400 may be a multi-phase motor comprising a plurality of motor windings. For example, the motor 400 may be a multi-phase alternating current (AC) motor. The plurality of motor windings comprises first motor windings 410 and second motor windings 420. The first motor windings 410 are electrically connected to the first ECU 100 and the third ECU 300 so that the motor 400 can be controlled or driven through the first motor windings 410 by either one of the first ECU 100 and the third ECU 300. The second motor windings 420 are electrically connected to the second ECU 200 and the third ECU 300 so that the motor 400 can be controlled or driven through the second motor windings 420 by either one of the second ECU 200 and the third ECU 300. In the exemplary embodiment shown in FIG. 1, the motor 400 is illustrated as a six-phase motor having three windings included in the first motor windings 410 connected to the first ECU 100 and the third ECU 300 and other three windings included in in the second motor windings 420 connected to the second ECU 200 and the third ECU 300, but it should be appreciated that the present disclosure should not be limited to such. One having ordinary skill in the art would understand that the present disclosure can be implemented with a less than six-phase motor or a more than six-phase motor according to the configurations of the first, second, and third ECUs 100, 200, and 300.

### First ECU

The first ECU 100 may comprise a first controller 110, a first driver 120, a first inverter 130, and a first phase disconnector 140. Additionally, the first ECU 100 may further include one or more of a first power supply regulator 150, a first current sensor 160, and a first communicator 170.

The first controller 110 may be configured to control one or more elements or components included in the first ECU 100 in order to control or drive the motor 400. For instance, the first controller 110 receives signals from the first current sensor 160 and other ECUs such as the second ECU 200 and the third ECU 300, and controls the first driver 120, the first phase disconnector 140, and the first power supply regulator 150. The first controller 110 is capable of communicating with the second ECU 200 and/or the third ECU 300 directly or indirectly through the first communicator 170. The first controller 110 may comprise, for example, but not limited to, one or more of a circuit, a microprocessor, a semiconductor based microprocessor (in the form of a microchip or chip set), a computer or processor, which monitors and physically alters the operating conditions of one or more elements or components of the first ECU 100. However, the first controller 110 can be any hardware device. Alternatively, the first controller 110 may not be included in the first ECU 100 and a main controller connected to the first ECU 100 may be configured to perform central control for the first ECU 100.

The first power supply regulator 150 may be configured to regulate or adjust the power supplied from the first power source 10. For instance, the first power supply regulator 150 may step down the power supply to a voltage level compatible for operating the first controller 110, the first driver 120, and the first inverter 130. The first power supply regulator 150 may include, for instance, but not limited to, a buck converter and/or a linear regulator to reduce the power voltage supplied from the first power source 10 to a first preset voltage for powering the first controller 110, a second preset voltage for powering the first driver 120, and a third preset voltage for powering the first inverter 130.

The first inverter 130 is electrically connected to the first motor windings 410 of the motor 400. The first inverter 130 may be configured to provide controlled electric power with variable magnitude and frequency to the first motor windings 410 of the motor 400. The first inverter 130 receives the power from the first power source 10 through the first power supply regulator 150, and converts the DC input (e.g. current or voltage) provided from the first power source 10 to the multi-phase AC output (e.g. current or voltage). The outputs generated by the first inverter 130 are applied to the first motor windings 410 to drive the multi-phase motor 400. The first inverter 130 may comprise multiple switches which may be any suitable switching devices, such as metal- oxide-semiconductor field-effect transistors (MOSFETs), insulated gate bipolar transistors (IGBTs), or any other suitable power semiconductor or transistor devices. For example, the first inverter 130 comprises the plurality of pairs of switches, typically transistors, and each of the pairs of switches comprises a top transistor and a bottom transistor connected in series.

The first driver 120 is configured to control the first inverter 130 to render direction, torque or speed control output from the motor 400. The first driver 120 may accomplish this task using several tools and can include any suitable processor configured to execute control logic that may control the first inverter 130 and the motor 400. The first driver 120 can be controlled by the first controller 110. For example, the first driver 120 may be an inverter gate driver configured to generate and output drive signals to gates of the switches included in the first inverter 130 in order to control the on and off of the switches of the first driver 120 according to pulse width modulation (PWM) duty-cycle commands received from the first controller 110. The drive signals of the first driver 120 may turn on or off the switches comprised in the first inverter 130 in order to regulate the fundamental component of the multi-phase voltage of the motor 400 to a desired amplitude, phase, and frequency. The first driver 120 may also include any other suitable devices or modules, such as ancillary devices like clocks, power supplies, and the like.

The first controller 110 is configured to control the first driver 120 in order to drive the switches included in the first inverter 130 so as to provide pulse width modulation of the first motor currents to the first motor windings 410. For example, the first driver 120 controlled by the first controller 110 may have six switch control outputs producing switch control signals to the control gates of the six switches comprised in the first inverter 130.

The first controller 110 is in communication with the first and second power sources 10 and 20 and may receive signals indicative of performance of the power source, such as battery state of charge, voltage feedback, current feedback or other parameters. The first controller 110 may further be in communication with other ECUs (e.g. the second ECU 200 and the third ECU 300) via a communication network such as the inter micro CAN (IMC).

The first phase disconnector 140 may be coupled between the first inverter 130 and the motor 400. The first phase disconnector 140 is configured to selectively connect or disconnect the first inverter 130 with or from the motor 400 and/or another inverter of the other ECU in response to a control signal of the first controller 110. When the first ECU 100 is in a non-active state or standby state or when the third ECU 300 supplies the first motor currents to the first motor windings 410 of the motor 400, the first phase disconnector 140 may disconnect the electric connection between the first inverter 130 of the first ECU 100 and the first motor windings 410 of the motor 400.

The details of exemplary embodiments of the first inverter 130 and the first phase disconnector 140 are described in U.S. application Ser. No. 17/367,563, filed on Jul. 5, 2021 and published as U.S. Patent Application Publication No. 2022/0014140, the entire teachings of which are incorporated by reference herein.

The first current sensor 160 may be configured to sense the motor phase currents flowing in the first inverter 130 or output to the first motor windings 410 of the motor 400. For instance, the first current sensor 160 may measure the current in each of the phases associated with the first motor windings 410 of the motor 400 by sampling the current at controlled times in the PWM period of the first controller 110.

The first communicator 170 of the first ECU 100 is configured to communicate with other ECUs 200 and/or 300 such as another communicator or controller of another ECU (e.g. the second ECU 200 and the third ECU 300). The first communicator 170 may transmit and receive signals to and from other ECUs 200 and/or 300 such as a communicator or a controller of another ECU by using one or more various communication methods designed for inter-micro communications, such as the protocols SCI, CAN, and MLI such as a local interconnect network (LIN) line or bus capable of two-way communications. However, the first communicator 170 may be integrated into the first controller 110.

### Second ECU

The second ECU 200 may comprise a second controller 210, a second driver 220, a second inverter 230, and a second phase disconnector 240. Additionally, the second ECU 200 may further include one or more of a second power supply regulator 250, a second current sensor 260, and a second communicator 270.

The second controller 210 may be configured to control one or more elements or components included in the second ECU 200 in order to control or drive the motor 400. For instance, the second controller 210 receives signals from the second current sensor 260 and other ECUs such as the first ECU 100 and the third ECU 300, and controls the second driver 220, the second phase disconnector 240, and the second power supply regulator 250. The second controller 210 is capable of communicating with the first ECU 100 and/or the third ECU 300 directly or indirectly through the second communicator 270. The second controller 210 may comprise, for example, but not limited to, one or more of a circuit, a microprocessor, a semiconductor based microprocessor (in the form of a microchip or chip set), a computer or processor, which monitors and physically alters the operating conditions of one or more elements or components of the second ECU 200. However, the second controller 210 can be any hardware device. Alternatively, the second controller 210 may not be included in the second ECU 200 and a main controller connected to the second ECU 200 may be configured to perform central control for the second ECU 200.

The second power supply regulator 250 may be configured to regulate or adjust the power supplied from the second power source 20. For instance, the second power supply regulator 250 may step down the power supply to a voltage level compatible for operating the second controller 210, the second driver 220, and the second inverter 230. The second power supply regulator 250 may include, for instance, but not limited to, a buck converter and/or a linear regulator to reduce the power voltage supplied from the second power source 20 to a first preset voltage for powering the second controller 210, a second preset voltage for powering the second driver 220, and a third preset voltage for powering the second inverter 230.

The second inverter 230 is electrically connected to the second motor windings 420. The second inverter 230 may be configured to provide controlled electric power with variable magnitude and frequency to the second motor windings 420 of the motor 400. The second inverter 230 receives the power from the second power source 20 through the second power supply regulator 250, and converts the DC input (e.g. current or voltage) provided from the second power source 20 to the multi-phase AC output (e.g. current or voltage). The outputs generated by the second inverter 230 are applied to the second motor windings 420 to drive the multi-phase motor 400. The second inverter 230 may comprise multiple switches which may be any suitable switching devices, such as metal-oxide-semiconductor field-effect transistors (MOSFETs), insulated gate bipolar transistors (IGBTs), or any other suitable power semiconductor or transistor devices. For example, the second inverter 230 comprises the plurality of pairs of switches, typically transistors, and each of the pairs of switches comprises a top transistor and a bottom transistor connected in series.

The second driver 220 is configured to control or drive the second inverter 230 to render direction, torque or speed control output from the motor 400. The second driver 220 may accomplish this task using several tools and can include any suitable processor configured to execute control logic that may control the second inverter 230 and the motor 400. The second driver 220 can be controlled by the second controller 210. For example, the second driver 220 may be an inverter gate driver configured to generate and output drive signals to gates of the switches included in the second inverter 230 in order to control the on and off of the switches of the second driver 220 according to pulse width modulation (PWM) duty-cycle commands received from the second controller 210. The drive signals of the second driver 220 may turn on or off the switches comprised in the second inverter 230 in order to regulate the fundamental component of the multi-phase voltage of the motor 400 to a desired amplitude, phase, and frequency. The second driver 220 may also include any other suitable devices or modules, such as ancillary devices like clocks, power supplies, and the like.

The second controller 210 is configured to control the second driver 220 in order to drive the switches included in the second inverter 230 so as to provide pulse width modulation of the second motor currents to the second motor windings 420. For example, the second driver 220 controlled by the second controller 210 may have six switch control outputs producing switch control signals to the control gates of the six switches comprised in the second inverter 130.

The second controller 210 is in communication with the first and second power sources 10 and 20 and may receive signals indicative of performance of the power source, such as battery state of charge, voltage feedback, current feedback or other parameters. The second controller 210 may further be in communication with other ECUs (e.g. the first ECU 100 and the third ECU 300) via a communication network such as the inter micro CAN (IMC).

The second phase disconnector 240 may be coupled between the second inverter 230 and the motor 400. The second phase disconnector 240 is configured to selectively connect or disconnect the second inverter 230 with or from the motor 400 and/or another inverter of the other ECU (e.g. the fourth inverter 330-2 of the third ECU 300) in response to a control signal of the second controller 210. When the second ECU 200 is in a non-active state or standby state, the second phase disconnector 240 may disconnect the electric connection between the second inverter 230 of the second ECU 200 and the second motor windings 420 of the motor 400.

The details of exemplary embodiments of the second inverter 230 and the second phase disconnector 240 are described in U.S. application Ser. No. 17/367,563, filed on Jul. 5, 2021 and published as U.S. Patent Application Publication No. 2022/0014140, the entire teachings of which are incorporated by reference herein.

The second current sensor 260 may be configured to sense the motor phase currents flowing in the second inverter 230 or output to the second motor windings 420 of the motor 400. For example, the second current sensor 260 may measure the current in each of the phases associated with the second motor windings 420 of the motor 400 by sampling the current at controlled times in the PWM period of the second controller 210.

The second communicator 270 of the second ECU 200 is configured to communicate with other ECUs 200 and/or 300 such as another communicator or controller of another ECU (e.g. the second ECU 200 and the third ECU 300). The second communicator 270 may transmit and receive signals to and from other ECUs 200 and/or 300 such as another communicator or controller of another ECU by using one or more various communication methods designed for inter-micro communications, such as the protocols SCI, CAN, and MLI. such as a local interconnect network (LIN or CAN) line or bus capable of two-way communications. However, the second communicator 270 may be integrated into the second controller 210.

### Third ECU

The third ECU 300 may comprise a third controller 310, third and fourth drivers 320-1 and 320-2, third and fourth inverters 330-1 and 330-2, and third and fourth phase disconnectors 340-1 and 340-2. Additionally, the third ECU 300 may further include one or more of a third power supply regulator 350, third and fourth current sensors 360-1 and 360-2, and a fourth communicator 370.

The third controller 310 may be configured to control one or more elements or components included in the third ECU 300 in order to control or drive the motor 400. For instance, the third controller 310 receives signals from the third and fourth current sensor 360-1 and 360-2 and other ECUs such as the first ECU 100 and the second ECU 200, and controls the third and fourth drivers 320-1 and 320-2, the third and fourth phase disconnectors 340-1 and 340-2, and the third power supply regulator 350. The third controller 310 is capable of communicating with the first ECU 100 and/or the second ECU 200 directly or indirectly through the third communicator 370. The third controller 310 may comprise, for example, but not limited to, one or more of a circuit, a microprocessor, a semiconductor based microprocessor (in the form of a microchip or chip set), a computer or processor, which monitors and physically alters the operating conditions of one or more components of the third ECU 300. However, the third controller 310 can be any hardware device. Alternatively, the third controller 310 may not be included in the third ECU 300 and a main controller connected to the third ECU 300 may be configured to perform central control for the third ECU 300.

The third power supply regulator 350 may be configured to regulate or adjust the power supplied from the first and second power sources 10 and 20. For instance, the third power supply regulator 350 may step down the power supply to a voltage level compatible for operating the third controller 310, the third and fourth drivers 320-1 and 320-2, and the third and fourth inverters 330-1 and 330-2. The third power supply regulator 350 may include, for instance, but not limited to, a buck converter and/or a linear regulator to reduce the power voltage supplied from the first and second power sources 10 and 20 to a first preset voltage for powering the third controller 310, a second preset voltage for powering the third and/or fourth drivers 320-1 and 320-2, and a third preset voltage for powering the third and/or fourth inverters 330-1 and 330-2.

The third inverter 330-1 is electrically connected to the first motor windings 410 of the motor 400 and the fourth inverter 330-2 is electrically connected to the second motor windings 420 of the motor 400. The third and fourth inverters 330-1 and 330-2 may be configured to provide controlled electric power with variable magnitude and frequency to the first and second motor windings 410 and 420, respectively. The third and fourth inverters 330-1 and 330-2 receive the power from the first and second power sources 10 and 20 through the third power supply regulator 350, and converts the DC input (e.g. current or voltage) provided from the first and second power sources 10 and 20 to the multi-phase AC output (e.g. current or voltage). The outputs generated by the third inverter 330-1 are applied to the first motor windings 410 and the outputs generated by the fourth inverter 330-2 are applied to the second motor windings 420 to drive the multi-phase motor 400. The third and fourth inverters 330-1 and 330-2 may comprise multiple switches which may be any suitable switching devices, such as metal-oxide-semiconductor field-effect transistors (MOSFETs), insulated gate bipolar transistors (IGBTs), or any other suitable power semiconductor or transistor devices. For example, each of the third and fourth inverters 330-1 and 330-2 comprises the plurality of pairs of switches, typically transistors, and each of the pairs of switches comprises a top transistor and a bottom transistor connected in series.

The third driver 320-1 is configured to control the third inverter 330-1 and the fourth driver 320-2 is configured to control the fourth inverter 330-2 to render direction, torque or speed control output from the motor 400. The third and fourth drivers 320-1 and 320-2 may accomplish this task using several tools and can include any suitable processor configured to execute control logic that may control the third and fourth inverters 330-1 and 330-2, respectively. Both the third and fourth drivers 320-1 and 320-2 can be controlled by the third controller 310. For example, the third and fourth drivers 320-1 and 320-2 may be an inverter gate driver configured to generate and output drive signals to gates of the switches included in the third and fourth inverters 330-1 and 330-2 in order to control the on and off of the switches of the third and fourth drivers 320-1 and 320-2 according to pulse width modulation (PWM) duty-cycle commands received from the third controller 310. The drive signals of the third and fourth drivers 320-1 and 320-2 may turn on or off the switches comprised in the third and fourth inverters 330-1 and 330-2 in order to regulate the fundamental component of the multi-phase voltage of the motor 400 to a desired amplitude, phase, and frequency. The third and fourth drivers 320-1 and 320-2 may also include any other suitable devices or modules, such as ancillary devices like clocks, power supplies, and the like.

The third controller 310 controls the third driver 320-1 in order to drive the switches in the third inverter 330-1 so as to provide pulse width modulation of the first motor currents to the first motor windings 410. And, third controller 310 controls the fourth driver 320-2 in order to drive the switches in the fourth inverter 330-2 so as to provide pulse width modulation of the first motor currents to the second motor windings 420. Accordingly, the third ECU 300 is capable of supplying the first motor current to the first motor windings 410 of the motor 400 as well as supplying the second motor current to the second motor windings 420 of the motor 400.

The third controller 310 is in communication with the first and second power sources 10 and 20 and may receive signals indicative of performance of the power source, such as battery state of charge, voltage feedback, current feedback or other parameters. The third controller 310 may further be in communication with other ECUs (e.g. the first ECU 100 and the second ECU 200) via a communication network such as the inter micro CAN (IMC).

The third phase disconnector 340-1 may be coupled between the third inverter 330-1 and the first motor windings 410 of the motor 400. The third phase disconnector 340-1 is configured to selectively connect or disconnect the third inverter 330-1 with or from the motor 400 and/or another inverter of the other ECU (e.g. the first inverter 130 of the first ECU 100) in response to a control signal of the third controller 310. When the third inverter 330-1 is in a non-active state or standby state, the third phase disconnector 340-1 may disconnect the electric connection between the third inverter 330-1 of the third ECU 300 and the first motor windings 410 of the motor 400.

The fourth phase disconnector 340-2 may be coupled between the fourth inverter 330-2 and the second motor windings 420 of the motor 400. The fourth phase disconnector 340-2 is configured to selectively connect or disconnect the fourth inverter 330-2 with or from the motor 400 and/or another inverter of the other ECU (e.g. the second inverter 230 of the second ECU 200) in response to a control signal of the third controller 310. When the fourth inverter 330-2 is in a non-active state or standby state, the fourth phase disconnector 340-2 may disconnect the electric connection between the fourth inverter 330-2 of the third ECU 300 and the second motor windings 420 of the motor 400.

The details of exemplary embodiments of the third and fourth inverters 330-1 and 320-2 and the third and fourth phase disconnectors 340-1 and 340-2 are described in U.S. application Ser. No. 17/367,563, filed on Jul. 5, 2021 and published as U.S. Patent Application Publication No. 2022/0014140, the entire teachings of which are incorporated by reference herein.

The third current sensor 360-1 may be configured to sense the motor phase currents flowing in the third inverter 330-1 or output to the first motor windings 410 of the motor 400. For example, the third current sensor 360-1 may measure the current in each of the phases associated with the first motor windings 410 of the motor 400 by sampling the current at controlled times in the PWM period of the third controller 310.

The fourth current sensor 360-2 may be configured to sense the motor phase currents flowing in the fourth inverter 330-2 or output to the second motor windings 420 of the motor 400. For example, the fourth current sensor 360-2 may measure the current in each of the phases associated with the second motor windings 420 of the motor 400 by sampling the current at controlled times in the PWM period of the third controller 310.

The third communicator 370 of the third ECU 300 is configured to communicate with other ECUs 100 and/or 200 such as another communicator or controller of another ECU (e.g. the first ECU 100 and the second ECU 200). The third communicator 370 may transmit and receive signals to and from other ECUs 100 and/or 200 such as another communicator or controller of another ECU by using one or more various communication methods designed for inter-micro communications, such as the protocols SCI, CAN, and MLI. such as a local interconnect network (LIN or CAN) line or bus capable of two-way communications. However, the third communicator 370 may be integrated into the third controller 310.

### Method and Operations for Controlling Motor Control System

Each of the first controller 110 of the first ECU 100, the second controller 210 of the second ECU 200, and the third controller 310 of the third ECU 300 monitors whether other ECUs are in a normal state or an abnormal state. The normal state may mean a state in the absence of a failure or fault such as a loss of power or communication. The abnormal state may include, for instance, but not limited to, a failure state which is termination of an intended operation of an element or an item due to a fault manifestation or a fault state which is an abnormal condition that can cause an element or an item to fail. For example, the abnormal state may be detected using Inter Micro CAN (e.g. the unavailability of communication of the Inter Micro CAN of a specific ECU), a sensor failure, correlation diagnostic, a loss of power and so on. In the exemplary embodiment of FIG. 1, the first controller 110 checks whether the second ECU 200 and the third ECU 300 are in a normal operation or an abnormal state, the second controller 210 checks whether the first ECU 100 and the third ECU 300 are in a normal operation or an abnormal state, and the third controller 310 checks whether the first ECU 100 and the second ECU 200 are in a normal operation or an abnormal state.

The first controller 110 of the first ECU 100, the second controller 210 of the second ECU 200, and the third controller 310 of the third ECU 300 also check whether the first power source 10 and the second power source 20 are in a normal state or an abnormal state

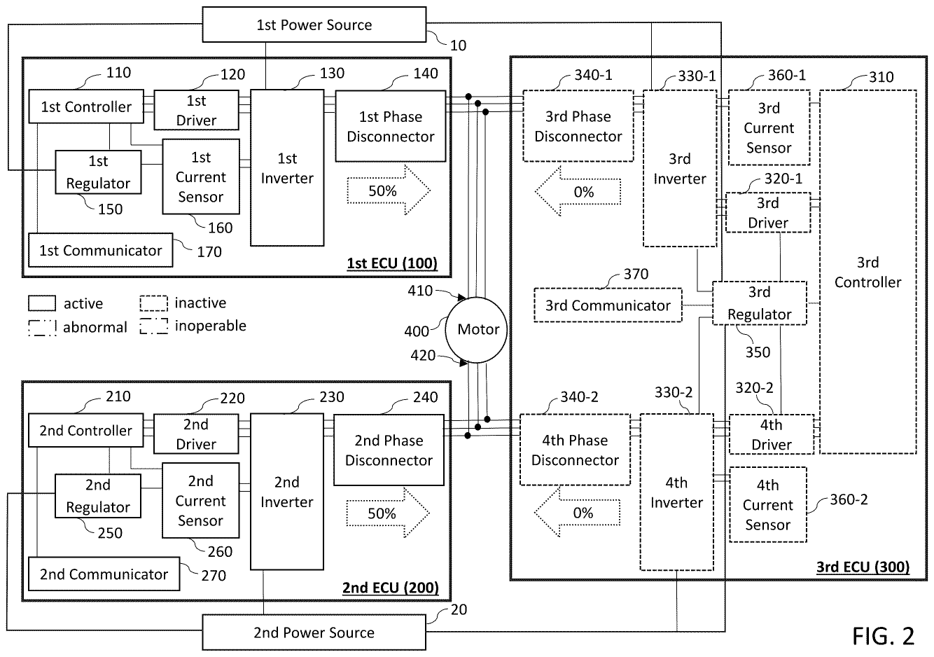

FIG. 2 shows an exemplary case in which the first ECU 100 and the second ECU 200 are in the normal state and the first power source 10 and the second power source 20 are in the normal state according to an embodiment of the present disclosure. Referring to FIG. 2, when the first ECU 100 and the second ECU 200 are in the normal state and the first power source 10 and the second power source 20 are in the normal state, the first ECU 100 provides first motor phase currents to the first motor windings 410 and the second ECU 200 provides second motor phase currents to the second motor windings 420, such that 50% of power for generating a torque by the motor 400 can be provided by the first ECU 100 and 50% of power for generating the torque by the motor 400 can be provided by the second ECU 200. In the exemplary case of FIG. 2, the third ECU 300 is in a non-active or standby state, and the third and fourth phase disconnectors 340-1 and 340-2 of the third ECU 300 may electrically disconnect the third and fourth inverters 330-1 and 330-2 from the loop of the motor control system such as the motor 110 and other ECUs (i.e. the second ECU 200 and third ECU 300). For instance, switches included in the third and fourth phase disconnectors 340-1 and 340-2 of the third ECU 300 are opened (e.g. turned off) to block the current therethrough.

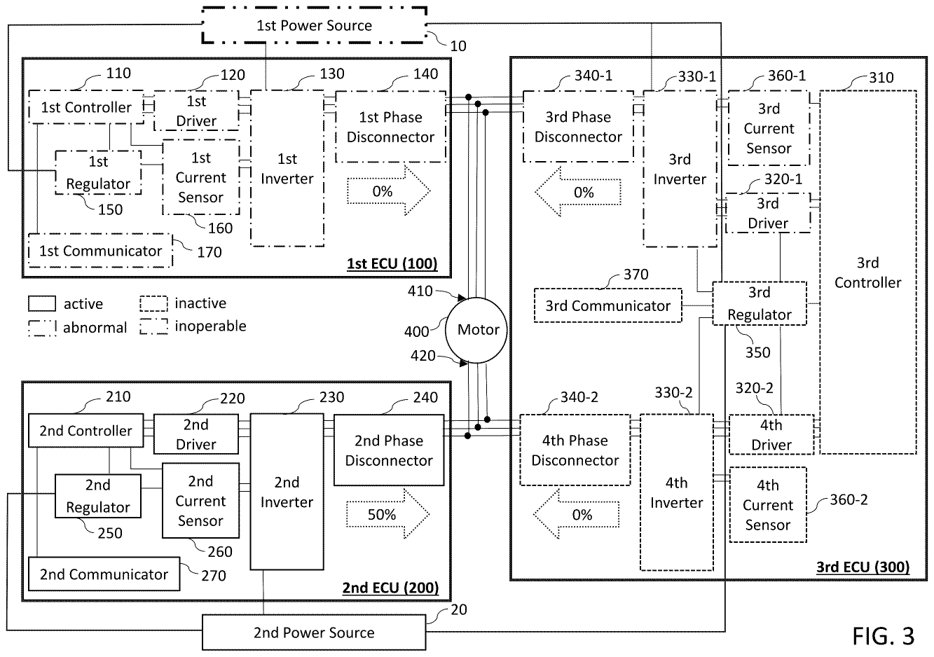

FIG. 3 illustrates an exemplary case in which the first power source 10 is in the abnormal state and the second power source 20 is in the normal state according to an embodiment of the present disclosure. Referring to FIG. 3, when the first power source 10 is in the abnormal state and the second power source 20 is in the normal state, all elements of the first ECU 100 (e.g. the first controller 110, the first driver 120, the first inverter 130, the first phase disconnector 140, the first power supply regulator 150, the first current sensor 160, and the first communicator 170) as well as the third driver 320-1, the third inverter 330-1, and the third phase disconnector 340-1 of the third ECU 300 are inoperable due to the abnormality of the first power source 10. Accordingly, the first ECU 100 and the third ECU 300 supply no drive current to the motor 400, but the second ECU 200 is capable of providing second motor phase currents to the second motor windings 420. Therefore, at least 50% of power for generating the torque by the motor 400 can be provided to the second motor windings 420 of the motor 400 by the second ECU 200. However, the fourth phase disconnector 340-2 of the third ECU 300 may disconnect the fourth inverter 330-2 from the second motor windings 420 and the second ECU 200, and the third controller 310, the fourth driver 320-2, the fourth inverter 330-2, the fourth current sensor 360-2, and the third communicator 370 of the third ECU 300 may be in an inactive or standby state.

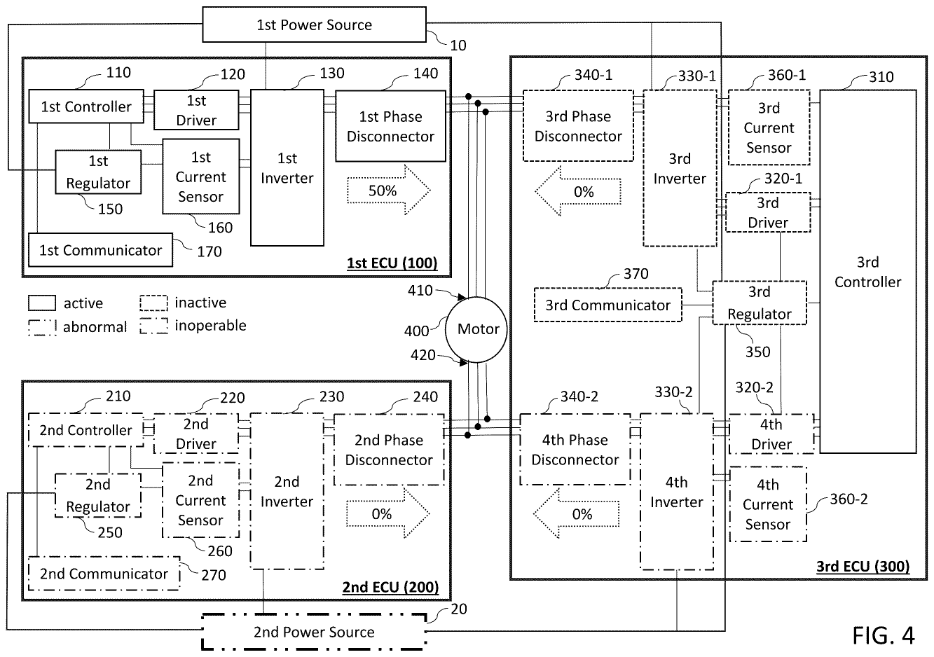

FIG. 4 shows an exemplary case in which the first power source 10 is in the normal state and the second power source 20 is in the abnormal state according to an embodiment of the present disclosure. Referring to FIG. 4, when the first power source 10 is in the normal state and the second power source 20 is in the abnormal state, all elements of the second ECU 200 (e.g. the second controller 210, the second driver 220, the second inverter 230, the second phase disconnector 240, the second power supply regulator 250, the second current sensor 260, and the second communicator 270) as well as the fourth driver 320-2, the fourth inverter 330-2, and the fourth phase disconnector 340-2 of the third ECU 300 are inoperable due to the abnormality of the second power source 20. Accordingly, the second ECU 100 and the third ECU 300 supply no current to the motor 400, but the first ECU 100 is capable of providing first motor phase currents to the first motor windings 410. Therefore, at least 50% of power for generating the torque by the motor 400 can be provided to the first motor windings 410 of the motor 400 by the first ECU 100. In this case, the third phase disconnector 340-1 of the third ECU 300 may disconnect the third inverter 330-1 from the first motor windings 410 and the first ECU 100, and the third controller 310, the third driver 320-1, the third inverter 330-1, the third current sensor 360-1, and the third communicator 370 of the third ECU 300 are in an inactive or standby state.

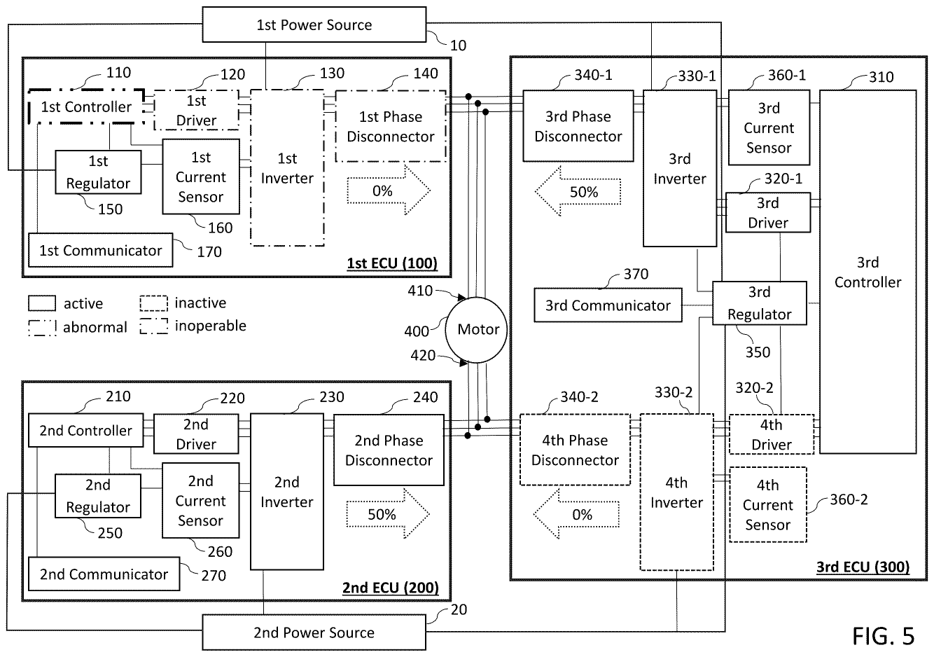

FIG. 5 shows an exemplary case in which the first controller 110 of the first ECU 100 is in the abnormal state according to an embodiment of the present disclosure. Referring to FIG. 5, when the first controller 110 of the first ECU 100 is in the abnormal state, the first driver 120, the first inverter 130, and the first phase disconnector 140 of the first ECU 100 are inoperable. However, the second ECU 200 is capable of providing the second motor currents to the second motor windings 420 of the motor 400. And, the third ECU 300 is capable of providing the first motor currents to the first motor windings 410 of the motor 400 by the control of the third controller 310 such that the operations performed by the third driver 320-1, the third inverter 330-1, the third current sensor 360-1, and/or the third communicator 370 of the third ECU 300 can supply the first motor currents to the first motor windings 410 of the motor 400. Thus, 50% of power for generating a torque by the motor 400 can be provided by the second ECU 100 and 50% of power for generating the torque by the motor 400 can be provided by the third ECU 300. In this case, the fourth phase disconnector 340-2 of the third ECU 300 may disconnect the fourth inverter 330-2 from the second motor windings 420 and the second ECU 200, and the third controller 310, the fourth driver 320-2, the fourth inverter 330-2, the fourth current sensor 360-2, and the third communicator 370 of the third ECU 300 may be in an inactive or standby state.

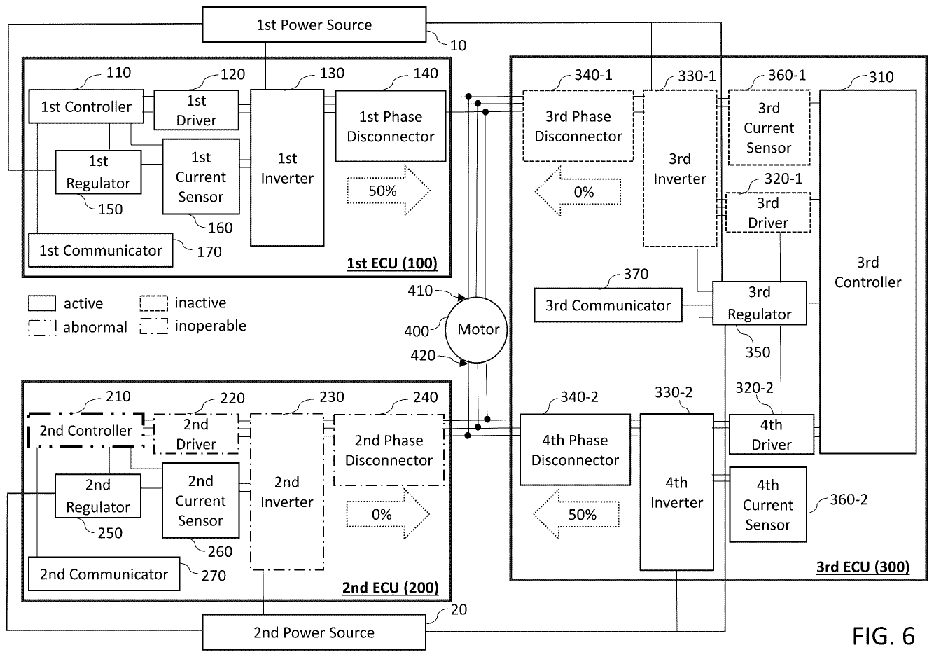

FIG. 6 illustrates an exemplary case in which the second controller 210 of the second ECU 200 is in the abnormal state according to an embodiment of the present disclosure. Referring to FIG. 6, when the second controller 210 of the second ECU 200 is in the abnormal state, the second driver 220, the second inverter 230, and the second phase disconnector 240 of the second ECU 200 are inoperable. However, the first ECU 100 in the normal state is capable of providing the first motor currents to the first motor windings 410 of the motor 400. And, the third ECU 300 is capable of providing the second motor currents to the second motor windings 420 of the motor 400 by the control of the third controller 310 such that the operations performed by the fourth driver 320-2, the fourth inverter 330-2, the fourth current sensor 360-2, and the third communicator 370 of the third ECU 300 can supply the second motor currents to the second motor windings 420 of the motor 400. Thus, 50% of power for generating a torque by the motor 400 can be provided by the first ECU 100 and 50% of power for generating the torque by the motor 400 can be provided by the third ECU 300. In this case, the third phase disconnector 340-1 of the third ECU 300 disconnects the third inverter 330-1 from the first motor windings 410 and the first ECU 100, and the third driver 320-1, the third inverter 330-1, and the third current sensor 360-1 of the third ECU 300 are in an inactive or standby state.

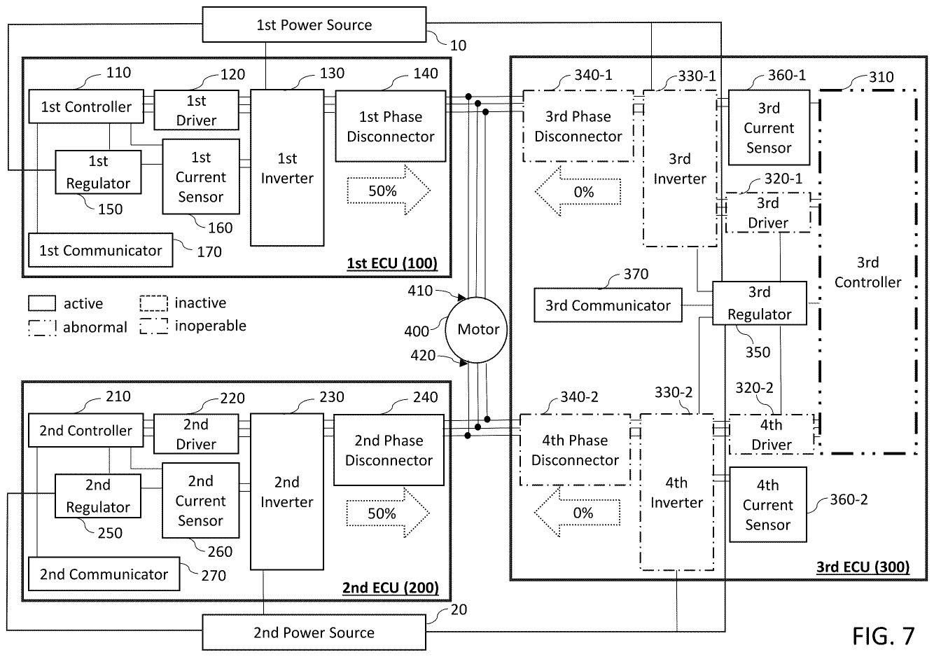

FIG. 7 shows an exemplary case in which the third controller 310 of the third ECU 300 is in the abnormal state according to an embodiment of the present disclosure. Referring to FIG. 7, when the third controller 310 of the third ECU 300 is in the abnormal state, the third and fourth drivers 320-1 and 320-2, the third and fourth inverters 330-1 and 330-2, and the third and fourth phase disconnectors 340-1 and 340-2 of the third ECU 300 are inoperable. In this case, the first ECU 100 is capable of providing the first motor phase currents to the first motor windings 410 and the second ECU 200 is capable of providing the second motor phase currents to the second motor windings 420, such that 50% of power for generating a torque by the motor 400 can be provided by the first ECU 100 and 50% of power for generating the torque by the motor 400 can be provided by the second ECU 200.

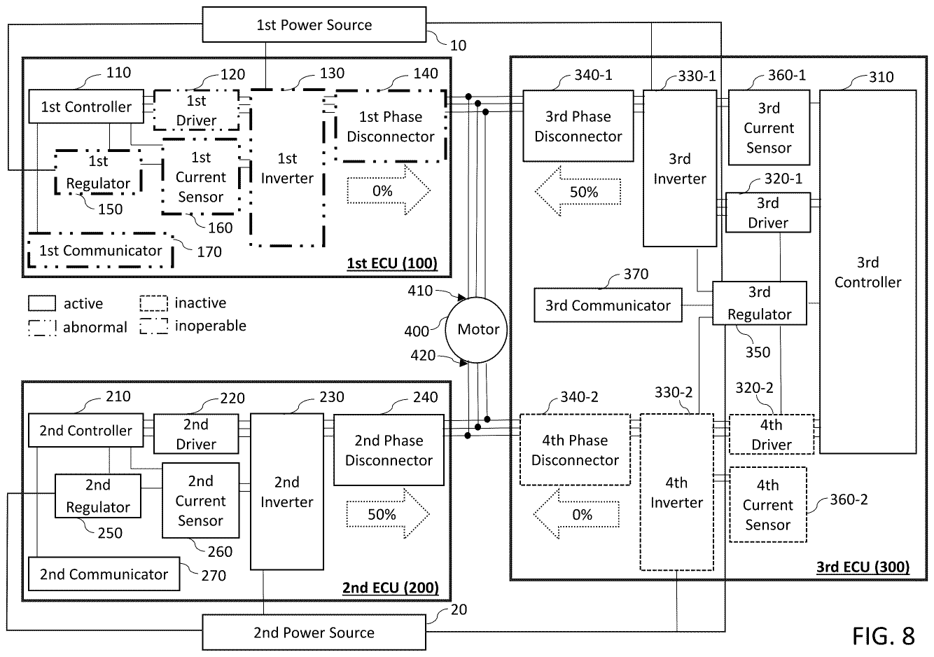

FIG. 8 illustrates an exemplary case in which one or more of the first driver 120, the first inverter 130, the first phase disconnector 140, the first power supply regulator 150, the first current sensor 160, and the first communicator 170 of the first ECU 100 are in the abnormal state according to an embodiment of the present disclosure. Referring to FIG. 8, when one or more of the first driver 120, the first inverter 130, the first phase disconnector 140, the first power supply regulator 150, the first current sensor 160, and the first communicator 170 of the first ECU 100 are in the abnormal state, the second ECU 200 and the third ECU 300 are capable of providing power for driving the motor 400. Specifically, the second ECU 200 can provide the second motor currents to the second motor windings 420 of the motor 400. And, the third ECU 300 can provide the first motor currents to the first motor windings 410 of the motor 400 by the control of the third controller 310 such that the operations performed by the third driver 320-1, the third inverter 330-1, the third power supply regulator 350, the third current sensor 360-1, and the third communicator 370 of the third ECU 300 can supply the first motor currents to the first motor windings 410 of the motor 400. Thus, 50% of power for generating a torque by the motor 400 can be provided by the second ECU 200 by supplying the second motor currents to the second motor windings 420 and 50% of power for generating the torque by the motor 400 can be provided by the third ECU 300 by supplying the first motor currents to the first motor windings 410. In this case, the fourth phase disconnector 340-2 of the third ECU 300 disconnects the fourth inverter 330-2 from the second motor windings 420 and the second ECU 200, and the fourth driver 320-2, the fourth inverter 330-2, and the fourth current sensor 360-2 of the third ECU 300 are in an inactive or standby state.

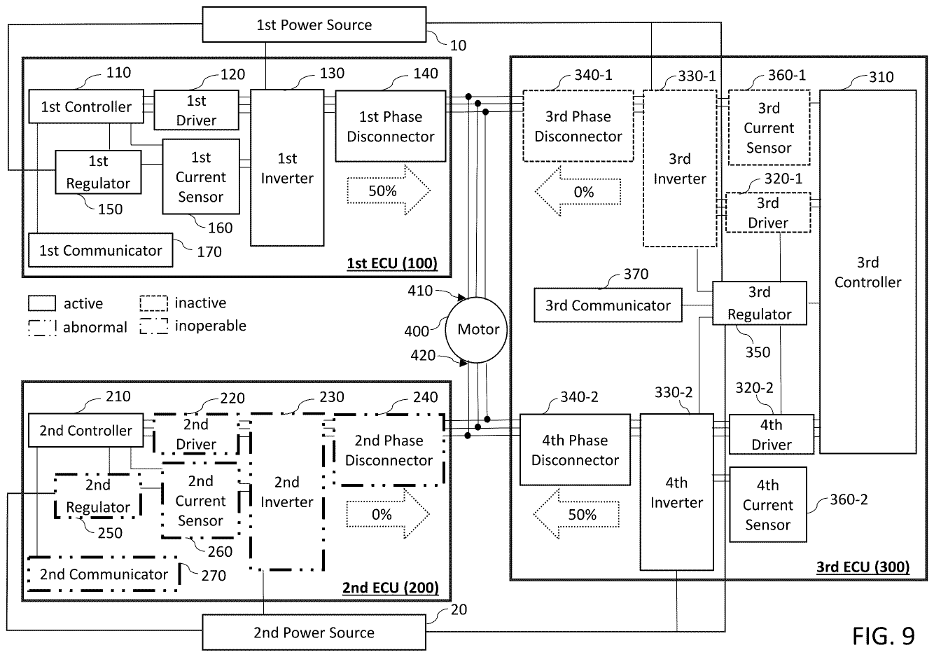

FIG. 9 shows an exemplary case in which one or more of the second driver 220, the second inverter 230, the second phase disconnector 240, the second power supply regulator 250, the second current sensor 260, and the second communicator 270 of the second ECU 200 are in the abnormal state according to an embodiment of the present disclosure. Referring to FIG. 9, when one or more of the second driver 220, the second inverter 230, the second phase disconnector 240, the second power supply regulator 250, the second current sensor 260, and the second communicator 270 of the second ECU 200 are in the abnormal state, the first ECU 100 and the third ECU 300 are capable of providing power for driving the motor 400. Specifically, the first ECU 100 can provide the first motor currents to the first motor windings 410 of the motor 400. And, the third ECU 300 can provide the second motor currents to the second motor windings 420 of the motor 400 by the control of the third controller 310 such that the operations performed by the fourth driver 320-2, the fourth inverter 330-2, the third power supply regulator 350, the fourth current sensor 360-2, and the third communicator 370 of the third ECU 300 can supply the second motor currents to the second motor windings 420 of the motor 400. Thus, 50% of power for generating a torque by the motor 400 can be provided by the first ECU 100 by supplying the first motor currents to the first motor windings 410 and 50% of power for generating the torque by the motor 400 can be provided by the third ECU 300 by supplying the second motor currents to the second motor windings 420. In this case, the third phase disconnector 340-1 of the third ECU 300 disconnects the third inverter 330-1 from the first motor windings 410 and the first ECU 100, and the third driver 320-1, the third inverter 330-1, and the third current sensor 360-1 of the third ECU 300 are in an inactive or standby state.

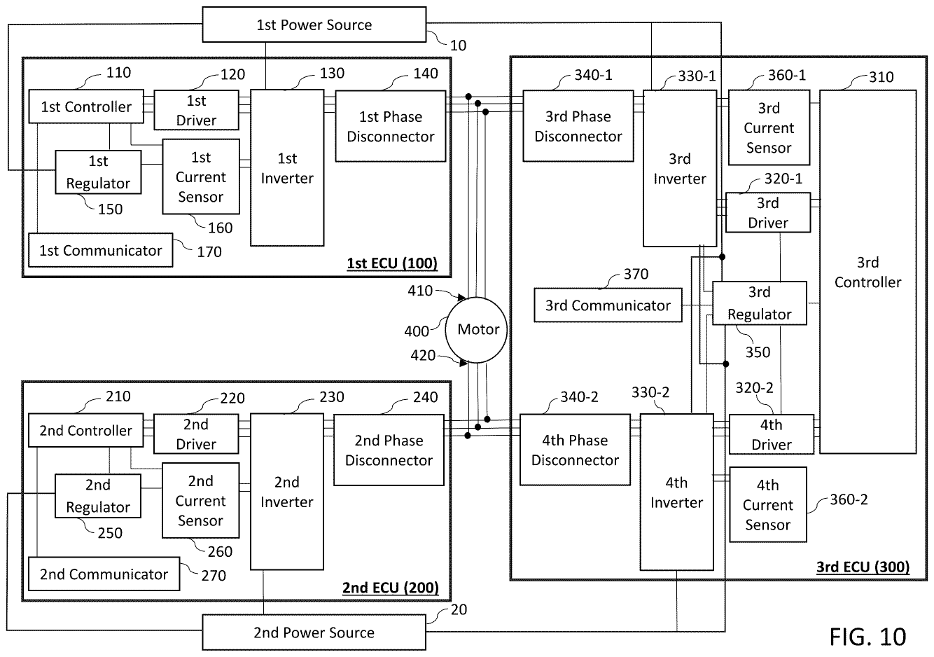

FIG. 10 illustrates a schematic diagram of a motor control system according to another embodiment of the present disclosure. In another embodiment of the present disclosure, the first power source 10 may be connected to the fourth inverter 330-2 of the third ECU 300 to supply power to the fourth inverter 330-2 of the third ECU 300, and the second power source 20 may be connected to the third inverter 330-1 of the third ECU 300 to supply power to the third inverter 330-1 of the third ECU 300. By this configuration of another exemplary embodiment, even one of the first power source 10 or the second power source 20 is in the abnormal state, 100% of power for generating the torque by the motor 300 can be provided to the motor 400.

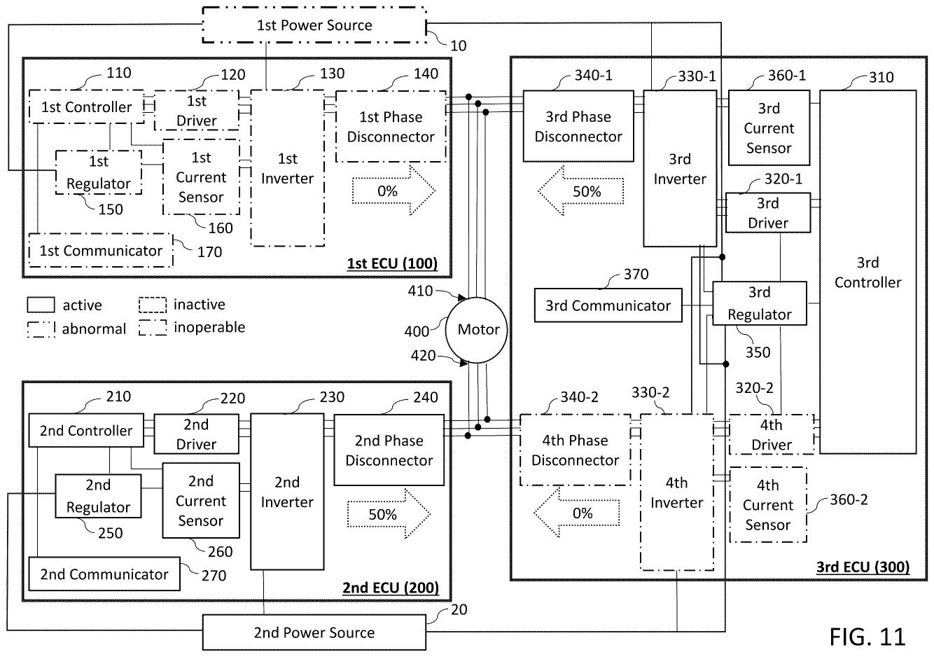

For instance, FIG. 11 illustrates an exemplary case in which the first power source 10 is in the abnormal state and the second power source 20 is in the normal state according to another embodiment of the present disclosure. Referring to FIG. 11, when the first power source 10 is in the abnormal state and the second power source 20 is in the normal state, all elements of the first ECU 100 (e.g. the first controller 110, the first driver 120, the first inverter 130, the first phase disconnector 140, the first power supply regulator 150, the first current sensor 160, and the first communicator 170) as well as the fourth driver 320-2, the fourth inverter 330-2, and the fourth phase disconnector 340-2 of the third ECU 300 are inoperable due to the abnormality of the first power source 10. However, because the second power source 20 is connected to the third inverter 330-1 of the third ECU 300, the third inverter 330-1 and the third power supply regulator 350 of the third ECU 300 can be powered by the second power source 20 so that first motor phase currents can be supplied to the first motor windings 410 of the motor 400 by the third inverter 330-1 of the third ECU 300. In addition, the second ECU 200 powered by the second power source 20 is capable of providing second motor phase currents to the second motor windings 420. Hence, 50% of power for generating a torque by the motor 400 can be provided by the third inverter 330-1 of the third ECU 300 by supplying the first motor currents to the first motor windings 410 by the third inverter 330-1 of the third ECU 300 and 50% of power for generating the torque by the motor 400 can be provided by the second ECU 200 by supplying the second motor currents to the second motor windings 420 by the second ECU 200. Therefore, another embodiment illustrated in FIG. 10 can provide 100% torque generated by the motor 400 even when failure in the first power source 10 occurs.

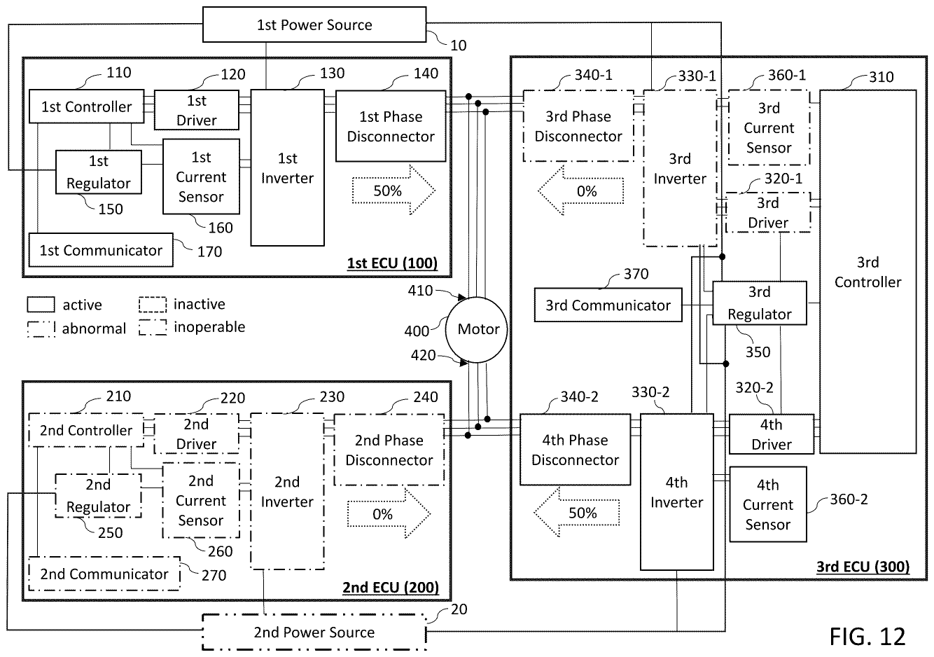

FIG. 12 illustrates another exemplary case in which the first power source 10 is in the normal state and the second power source 20 is in the abnormal state according to another embodiment of the present disclosure. Referring to FIG. 12, when the first power source 10 is in the normal state and the second power source 20 is in the abnormal state, all elements of the second ECU 200 (e.g. the second controller 210, the second driver 220, the second inverter 230, the second phase disconnector 240, the second power supply regulator 250, the second current sensor 260, and the second communicator 270) as well as the third driver 320-1, the third inverter 330-1, and the third phase disconnector 340-1 of the third ECU 300 are inoperable due to the abnormality of the second power source 20. However, because the first power source 10 is connected to the fourth inverter 330-2 of the third ECU 300, the fourth inverter 330-2 and the third power supply regulator 350 of the third ECU 300 can be powered by the first power source 10 so that second motor phase currents can be supplied to the second motor windings 420 of the motor 400 by the fourth inverter 330-2 of the third ECU 300. In addition, the first ECU 100 powered by the first power source 10 is capable of providing first motor phase currents to the first motor windings 410. Hence, 50% of power for generating the torque by the motor 400 can be provided by the first ECU 100 by supplying the first motor currents to the first motor windings 410 by the first ECU 100 and 50% of power for generating a torque by the motor 400 can be provided by the fourth inverter 330-2 of the third ECU 300 by supplying the second motor currents to the second motor windings 420 by the fourth inverter 330-2 of the third ECU 300. Therefore, another embodiment illustrated in FIG. 10 can provide 100% torque generated by the motor 400 even when failure in the second power source 20 occurs.

Therefore, the motor control system and method according to some exemplary embodiments of the present disclosure described above may maintain the control of a vehicle by providing at least 50% torque supply (e.g. 50% or 100% torque supply) even after abnormality such as failure or fault occurs in two or more of the plurality of electronic control units, one or more of the plurality of power sources, or one or some components of two or more of the plurality of electronic control units. And, according to certain exemplary embodiments of the present disclosure, redundancy may be provided in case of two point failure in the plurality of ECUs. Accordingly, the motor control system and method according to certain exemplary embodiments of the present disclosure may have various redundancies to ensure safe and proper handling of the vehicle in fallback conditions and achieve higher safety levels.

Although the example embodiments have been described in detail, it should be understood that various changes, substitutions and alterations can be made herein without departing from the spirit and scope of the application as defined by the appended claims.

In the present disclosure, relational terms such as first and second, and the like may be used solely to distinguish one entity or action from another entity or action without necessarily requiring or implying any actual such relationship or order between such entities or actions. Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements. The term “connected” or “coupled” may mean direct or indirect connection unless otherwise specified.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

What is claimed is:

1. A motor drive system comprising:
a motor comprising a plurality of motor windings;
first and second power sources;
a first electronic control unit electrically connected with the first power source to receive power from the first power source and electrically connected with the motor to control the motor, the first electronic control unit comprising a first inverter, a first driver configured to drive the first inverter, and a first microcontroller configured to control the first drive;
a second electronic control unit electrically connected with the second power source to receive the power from the second power source and electrically connected with the motor to control the motor, the second electronic control unit comprising a second inverter, a second driver configured to drive the second inverter, and a second microcontroller configured to control the second driver; and
a third electronic control unit electrically connected with the first and second power sources to receive the power from the first and second power sources and electrically connected with the motor to control the motor, the third electronic control unit comprising third and fourth inverters, third and fourth drivers configured to drive the third and fourth inverters, respectively, and a third microcontroller configured to control the third and fourth drivers.

2. The motor drive system of claim 1, wherein:
the first electronic control unit further comprises a first regulator configured to regulate the power supplied from the first power source to the first electronic control unit;
the second electronic control unit further comprises a second regulator configured to regulate power supplied from the second power source to the second electronic control unit; and
the third electronic control unit further comprises a third regulator configured to regulate power supplied from the first and second power sources to the third electronic control unit.

3. The motor drive system of claim 1, wherein:
the first electronic control unit further comprises a first phase disconnector connected between the first inverter and the motor and configured to selectively disconnect electrical connection between the first inverter and the motor;
the second electronic control unit further comprises a second phase disconnector connected between the second inverter and the motor and configured to selectively disconnect electrical connection between the second inverter and the motor; and
the third electronic control unit further comprises a third phase disconnector connected between the third inverter and the motor and configured to selectively disconnect electrical connection between the third inverter and the motor and a fourth phase disconnector connected between the fourth inverter and the motor and configured to selectively disconnect electrical connection between the fourth inverter and the motor.

4. The motor drive system of claim 1, wherein:
the plurality of motor windings of the motor comprise first motor windings and second motor windings;
the first electronic control unit further comprises a first current sensor configured to sense first motor phase currents which are to be provided to the first motor windings of the motor;
the second electronic control unit further comprises a second current sensor configured to sense second motor phase currents which are to be provided to the second motor windings of the motor; and
the third electronic control unit further comprises a third current sensor configured to sense the first motor phase currents which are to be provided to the first motor windings of the motor and a fourth current sensor configured to sense the second motor phase currents which are to be provided to the second motor windings of the motor.

5. The motor drive system of claim 1, wherein the first, second and third electronic control units are communicationally connected to each other.

6. The motor drive system of claim 1, wherein the plurality of motor windings of the motor comprise first motor windings, connected to the first invertor of the first electronic control unit and the third invertor of the third electronic control unit, and second motor windings, connected to the second invertor of the second electronic control unit and the fourth invertor of the third electronic control unit.

7. The motor drive system of claim 6, wherein:
the first electronic control unit is configured to, when the first power source and the first electronic control unit are in a normal state, provide first motor phase currents to the first motor windings of the motor connected to the first invertor of the first electronic control unit and the third invertor of the third electronic control unit; and
the second electronic control unit is configured to, when the second power source and the second electronic control unit are in the normal state, provide second motor phase currents to the second motor windings of the motor connected to the second invertor of the second electronic control unit and the fourth invertor of the third electronic control unit.

8. The motor drive system of claim 6, wherein:
the third electronic control unit is configured to, when the first electronic control unit is in an abnormal state and the second electronic control unit is in a normal state, provide first motor phase currents to the first motor windings of the motor connected to the first invertor of the first electronic control unit and the third invertor of the third electronic control unit; and
the second electronic control unit is configured to, when the first electronic control unit is in the abnormal state and the second electronic control unit is in the normal state, provide second motor phase currents to the second motor windings of the motor connected to the second invertor of the second electronic control unit and the fourth invertor of the third electronic control unit.

9. The motor drive system of claim 6, wherein:
the third electronic control unit is configured to, when the first electronic control unit is in a normal state and the second electronic control unit is in an abnormal state, provide second motor phase currents to the second motor windings of the motor connected to the second invertor of the second electronic control unit and the fourth invertor of the third electronic control unit; and
the first electronic control unit is configured to, when the first electronic control unit is in the normal state and the second electronic control unit is in the abnormal state, provide first motor phase currents to the first motor windings of the motor connected to the first invertor of the first electronic control unit and the third invertor of the third electronic control unit.

10. The motor drive system of claim 6, wherein the third electronic control unit is configured to, when the first electronic control unit and the second electronic control unit are in an abnormal state, provide first and second motor phase currents to the first and second motor windings of the motor.

11. The motor drive system of claim 6, wherein:
the first electronic control unit is configured to, when the third electronic control unit is in an abnormal state and the first and second electronic control units are in a normal state, provide first motor phase currents to the first motor windings of the motor connected to the first invertor of the first electronic control unit and the third invertor of the third electronic control unit; and
the second electronic control unit is configured to, when the third electronic control unit is in the abnormal state and the first and second electronic control units are in a normal state, provide second motor phase currents to the second motor windings of the motor connected to the second invertor of the second electronic control unit and the fourth invertor of the third electronic control unit.

12. The motor drive system of claim 6, wherein the first electronic control unit is configured to, when the second power source configured to supply the power to the second electronic control unit and the third electronic control unit is in an abnormal state, provide first motor phase currents to the first motor windings of the motor connected to the first invertor of the first electronic control unit and the third invertor of the third electronic control unit.

13. The motor drive system of claim 6, wherein the second electronic control unit is configured to, when the first power source configured to supply the power to the first electronic control unit and the third electronic control unit is in an abnormal state, provide second motor phase currents to the second motor windings of the motor connected to the second invertor of the second electronic control unit and the fourth invertor of the third electronic control unit.

14. The motor drive system of claim 8, wherein the second and/or third electronic control units are configured to determine whether the first electronic control unit is in the abnormal state based on one or more of a loss of the power supplied from the first power source or a disconnection of communication from the first electronic control unit.

15. The motor drive system of claim 9, wherein the first and/or third electronic control units are configured to determine whether the second electronic control unit is in the abnormal state based on one or more of a loss of the power supplied from the second power source or a disconnection of communication from the second electronic control unit.

16. The motor drive system of claim 10, wherein the third electronic control unit is configured to determine whether the first or second electronic control unit is in the abnormal state based on one or more of a loss of the power supplied from the first or second power source or a disconnection of communication from the first or second electronic control unit.

17. A method for controlling a motor drive system comprising a motor comprising first and second motor windings; first and second power sources; a first electronic control unit comprising a first inverter connected to the first motor windings, electrically connected with the first power source to receive power from the first power source, and electrically connected with the first motor windings of the motor to control the motor; a second electronic control unit comprising a second inverter connected to the first motor windings, electrically connected with the second power source to receive the power from the second power source, and electrically connected with the second motor windings of the motor to control the motor; and a third electronic control unit having a third invertor connected to the first motor windings and a fourth invertor connected to the second motor windings, electrically connected with the first and second power sources to receive the power from the first and second power sources, and electrically connected with the motor to control the motor, the method comprising:
when the first electronic control unit is in an abnormal state, providing, by the third electronic control unit, first motor phase currents to the first motor windings of the motor connected to the first invertor of the first electronic control unit and the third invertor of the third electronic control unit and providing, by the second electronic control unit, second motor phase currents to the second motor windings of the motor connected to the second invertor of the second electronic control unit and the fourth invertor of the third electronic control unit; and
when the second electronic control unit is in the abnormal state, providing, by the third electronic control unit, second motor phase currents to the second motor windings of the motor connected to the second invertor of the second electronic control unit and the fourth invertor of the third electronic control unit and providing, by the first electronic control unit, first motor phase currents to the first motor windings of the motor connected to the first invertor of the first electronic control unit and the third invertor of the third electronic control unit.

18. The method of claim 17, further comprising, when the first and second power sources and the first and second electronic control unit are in a normal state, providing, by the first electronic control unit, first motor phase currents to the first motor windings of the motor connected to the first invertor of the first electronic control unit and the third invertor of the third electronic control unit and providing, by the second electronic control unit, second motor phase currents to the second motor windings of the motor connected to the second invertor of the second electronic control unit and the fourth invertor of the third electronic control unit.

19. The method of claim 17, further comprising, when the first and second electronic control units are in the abnormal state, providing, by the third electronic control unit, the first motor phase currents to the first motor windings of the motor connected to the first invertor of the first electronic control unit and the third invertor of the third electronic control unit and providing, by the third electronic control unit, second motor phase currents to the second motor windings of the motor connected to the second invertor of the second electronic control unit and the fourth invertor of the third electronic control unit.

20. The method of claim 17, further comprising:
when the second power source configured to supply the power to the second electronic control unit and the third electronic control unit is in the abnormal state, providing, by the first electronic control unit, the first motor phase currents to the first motor windings of the motor connected to the first invertor of the first electronic control unit and the third invertor of the third electronic control unit; and
when the first power source configured to supply the power to the first electronic control unit and the third electronic control unit is in the abnormal state, providing, by the second electronic control unit, the second motor phase currents to the second motor windings of the motor connected to the second invertor of the second electronic control unit and the fourth invertor of the third electronic control unit.
